(19) United States
(12) Patent Application Publication
(10) Pub. No.: US 2004/0155624 A1
(43) Pub. Date: Aug. 12, 2004

(54) Power supply system

(76) Inventors: Masahiko Amano, Hitachiota (JP); Hideki Miyazaki, Hitachi (JP); Takuya Kinoshita, Hitachi (JP); Hiroshi Kanazawa, Hitachiota (JP)

Correspondence Address: CROWELL & MORING LLP, INTELLECTUAL PROPERTY GROUP, P.O. BOX 14300, WASHINGTON, DC, 20044-4300, US

(21) Appl. No.: 10/718,552

(22) Filed: Nov. 24, 2003

(30) Foreign Application Priority Data
Dec. 6, 2002 (JP) 2002-355813

(51) Int. Cl. H02J 7/00

(52) U.S. Cl. 320/104

(57) ABSTRACT

A power supply system having a power supply including an electric generator and a battery, and a power control unit for controlling electric power supplied from said power supply to an electric load, wherein the power supply system has battery condition sensing means for sensing the operative condition of the battery and load condition sensing means for sensing the operative condition of the electric load, and the power supply system has a function in which the variation of the power supply voltage at the time of the operative requirement of the electric load is estimated based on the condition of said battery and the operative condition of said electric load, and the current of the electric load is limited when the estimated electric power supply voltage is smaller than a predetermined value.

### BACKGROUND OF THE INVENTION

The present invention relates to a power supply system for supplying electric power to various electrical equipments, and particularly a power supply system intended to use in a viable such as an automobile or the like.

The electric load of an automobile increases every year. A seat heater and/or windshield heater which are of a high capacity electric load are adopted in the automobile, and in order to intend to increase controllability and efficiency, an electrified system began to be adopted in place of conventional equipments operating at hydraulic pressure or engine power. Furthermore, a dynamo-electric brake, an electric power steering system or the like tends to be utilized as an electric load which needs high reliability.

The increase of these electric loads needs to increase the capacity of the electric generator or battery, but there is a limitation relating to the point of mounting or cost. Therefore, in case where an excessive load power was generated, there is the possibility that the voltage of the power supply system greatly drops by the discharge of the battery.

The voltage drop arising from the discharge of the battery becomes particularly large when the survival capacity of the battery becomes small after long discharge, or when internal resistance is large in the state of a low ambient air temperature (for example, −30 degree centigrade), or the like. Also, when battery deterioration made progress, the voltage drop becomes large. The drop of the battery voltage leads to the voltage drop of the power supply system as it is, and in some case, the controller will become inoperative, as a result the output of the electric load can not be generated sufficiently.

Japanese Patent Application Laid-Open No. 2000-326805 discloses a method for discriminating electric loads according to their level of importance, and shutting off the load having a lower level of importance in case where the load electric power is large. In the illustrated example, the loads are classified into two groups, and the loads having the lower level importance are shut off when the total load current exceeded a certain value.

With the above-mentioned method, since the load is shut off based on the total load current independent of the status of the battery and the maximum output current of the electric generator, there is the danger that the load is shut off more than necessary or in reverse the necessary load shut-off amount can not be obtained.

Further, since this method shuts off after sensing the current, there is the danger that transient voltage drop generates when a high capacity load is abruptly turned on.

### SUMMARY OF THE INVENTION

An object of the present invention is to provide a power supply system with high reliability which can certainly avoid the voltage drop at the time of the load turning-on.

Another object of the present invention is to provide a power supply system with high reliability which can certainly avoid the transient voltage drop at the time of the load turning-on.

In accordance with the power supply system of the present invention, it has a power supply including an electric generator and a battery, and a power control unit for electric power supplied from said power supply to an electric load, said power supply system having battery status sensing means for sensing the status of said battery and load status sensing means for sensing the operative condition of said electric load, and said power supply system having a function in which the variation of the power supply voltage at the time of the operative requirement of said electric load is anticipated based on the condition of said battery and the operative condition of said electric load, and the current of the electric load is limited when said anticipated electric power supply voltage is smaller than a predetermined value.

### BRIEF DESCRIPTION OF THE DRAWINGS

FIG. 1 is a diagram showing an arrangement of an automobile power supply system including a power supply system according to the present invention.

FIG. 2 is a diagram showing an arrangement of a power control unit according to the present invention.

FIG. 3 is a flaw chart showing the processes of the power control unit according to the present invention.

FIG. 4 is a diagram showing an arrangement of a load control instructing part according to the present invention.

### DESCRIPTION OF THE PREFERRED EMBODIMENTS

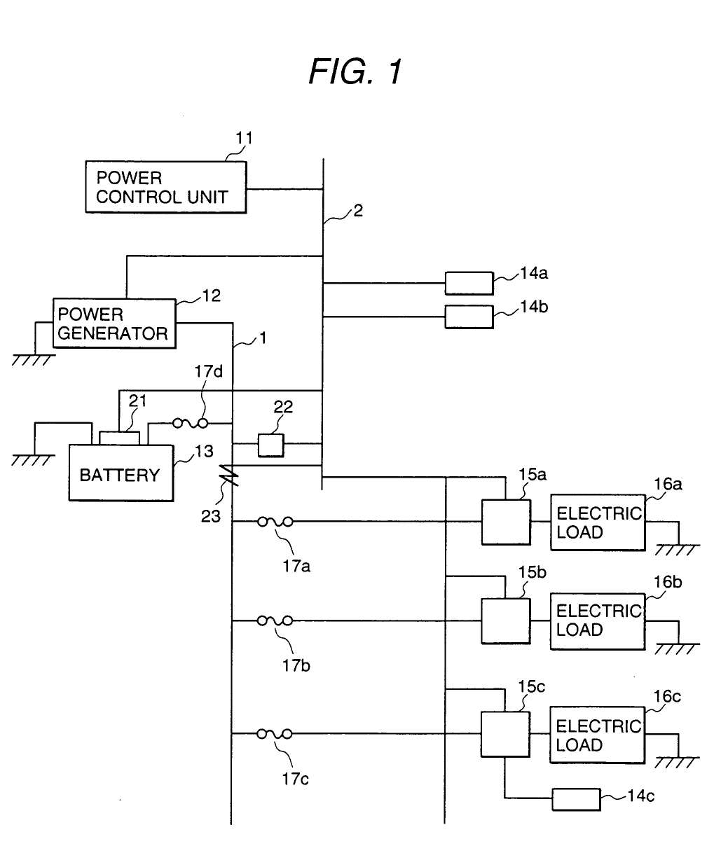

Hereinafter, the modes of embodiments of the present invention will be explained using the drawings. First, an example of a power supply system for an automobile according to the present invention is explained in reference to FIG. 1. The power supply system of this example has a power supply and a power control unit 11 for controlling power supplies supplied to various electric loads mounted to the automobile. The power supply has an electric generator 12 coupled to an engine (not shown) and a battery 13 for supplying direct current power supplies to various electric loads.

A power supply line 1 for supplying the power supply is connected to the electric generator 12 and the battery 13. The battery 13 is connected to the power supply line 1 through a fuse 17d. To this power supply line 1, a plurality of electric loads 16a, 16b and 16c are connected through fuses 17a, 17b and 17c and load controllers 15a, 15b and 15c. FIG. 1 shows only three electric loads, but actually many electric loads are connected.

To power control unit 11, a communication line 2 for transmitting a signal is connected. To this communication line 2, the electric generator 12, manual operation switches 14a and 14b, a battery sensor 21 for detecting the battery condition of the battery 13, a voltage sensor 22 for detecting the voltage of the power supply line 1, a current sensor 23 for detecting the current of the power supply line 1, and the load controllers 15a˜15c for controlling the electric loads 16a˜16c are connected. In this example, the load controllers 15a˜15c have a function as a sensor for detecting the operative condition of the electric loads 16a˜16c. To the third load controller 15c, an operation switch 14c is connected.

The electric loads 16a˜16c may be for example heaters, electrically operated brakes, or electrically operated power steering machines. The load controllers 15a˜15c include relays, semiconductor switches and the like for controlling load ON/OFF. Alternately, they may include PWM controllers and invertors for controlling the load output serially.

To the electric loads 16a˜16c, usually the electric power is supplied from the electric generator 12. When the engine is stopped or when large load power exceeding the electric generator output is necessary, an electric power is supplied from the battery 13.

To the power control unit 11, information such as the battery current, battery voltage and temperature is transmitted from the battery sensor 21 mounted on the battery 13. Also, from the voltage sensor 22 the voltage value of the power supply line 1 is transmitted, and from the current sensor 23 the total current value of the electric loads is transmitted. Further, from the load controllers 15a˜15c, the load ON/OFF condition information of the load current, a load current demand value or the like is transmitted.

An operation signal from an operator to the electric loads 16a˜16c is applied from the operation switches 14a and 14b through the communication line 2 to the load controller 15a and 15b, and at the same time is applied to the power control unit 11. Also, to the electric load 16c the operation signal from the operator may be supplied directly to the load controller 15c from the operation switch 14c. In this case, the operation information is transmitted from the load controller 15c through the communication line 2 to the power control unit 22.

The power control unit 11 outputs control signals the electric generator 12 and the load controllers 15a˜15c based on the sensors 21, 22 and 23, the operation switches 14a and 14b and the load controllers 15a˜15c, and controls the voltage of the power supply line 1. The control signal may be a voltage command value for the electric generator 12, or ON/OFF command or current command for the load controllers 15a˜15c or the like. In this example, the exchange of input communication and control signals necessary for control is carried out using LAN (Local Aria Network) on the communication line 22.

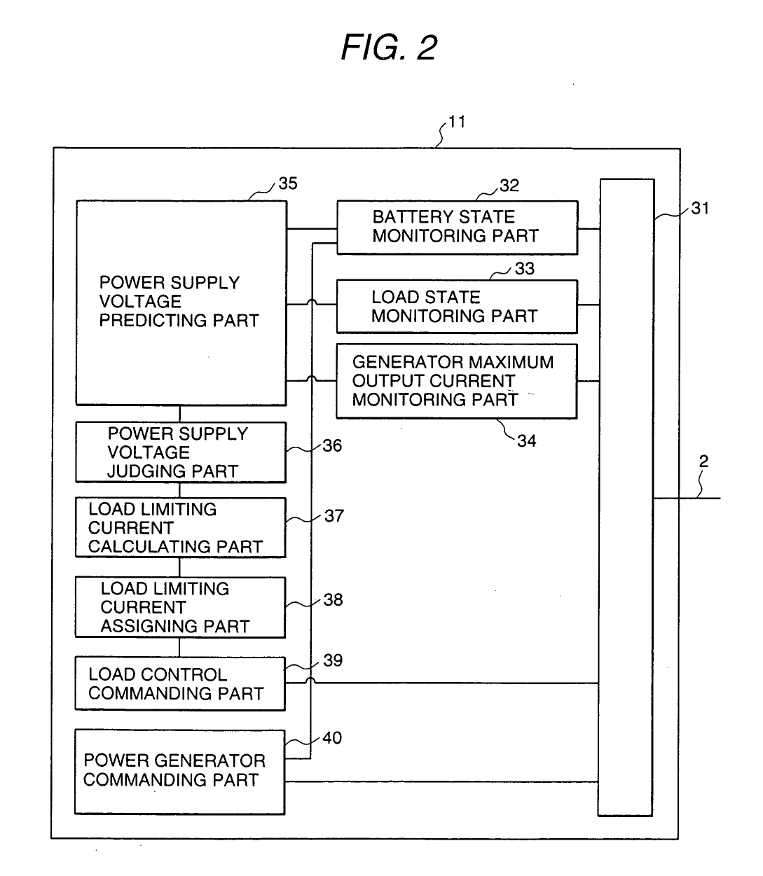

With reference to FIG. 2, an example of arrangement of the power control unit 11 is explained. The power control unit 11 of this example has a LAN interface 31 transmitting to various parts information input/output through the communication line 2, a battery condition monitoring part 32 sensing the battery condition based on battery condition information supplied from the battery sensor 21, a load condition monitoring part 33 sensing the operation conditions of the respective electric loads, an electric generator maximum output current monitoring part 34 sensing the electric generator maximum output current, a power supply voltage predicting part 35 calculating the prediction value of the load current based on the battery condition, the operative condition of the electric loads and the electric generator maximum output current and predicting the power supply voltage based on the prediction value of said load current, a power supply voltage judging part 36 jading whether said predicted power supply voltage is smaller than a predetermined value, a load limitation current calculating part 36 calculating the load limitation current when the predicted power supply voltage is smaller than the predetermined value, a load limit current assigning 38 assigning said calculated load limit current to the respective electric loads, a load control commanding part 39 generating control signals to the respective electric loads, and an electric generator commanding part 40 commanding a voltage target value to the electric generator 12.

The battery condition monitoring part 32 supposes parameters relating to the battery conditions such as the charge condition, deteriorated condition, open-circuit voltage, internal resistance of the battery based on the information such as the current, voltage, temperature and the like.

As the method of this supposition, various ones have been developed, so the detailed explanation is omitted. For example, as the method for supposing the charge condition, there is a method in which initial charge condition at the time of key-on is obtained from the battery voltage, and by multiplying charge/discharge current thereafter the change of the discharge condition is obtained. Also, as the method for supposing the internal resistance, there is a method in which the supposition is carried out by the relationship of the current and voltage.

Various correlations reside in among these parameters relating to the battery condition, so a database for the correlation prepared in the form of a map can be preferably used. The respective parameters are supposed by inquiring the actual measured value and the map.

In general the battery voltage, that is the terminal voltage of the battery Vb can be shown as the following equation.

Vb=Vo+Vp−R×Ib (1)

In this equation, Vo is open-circuit voltage, Vp is polarization voltage, R is internal resistance, and Ib is battery current. The battery current is defined to positive at the discharging side, and negative at the charging side. The open-circuit voltage means voltage at the time when the terminal of the battery was made to the open-circuit. The polarization voltage means a component of voltage generated by the charge and discharge (voltage change due to the internal resistance R×Ib is excluded). This increases/decreases with time. Within these variables, the terminal voltage Vb and the battery current 1b can be obtained by measurement. Therefore, if the open-circuit voltage and the internal resistance can be supposed, the residual polarization voltage can also be judged.

If these parameters can be supposed, it is possible to suppose the amount of decrease of the battery voltage Vb responding to the amount of increases of the battery current Ib when a large capacity electric load was put in.

The load condition monitoring part 33 senses the ON/OFF condition of the electric loads, current every electric load, current the whole electric loads and the like. In case where the ON/OFF condition is input as information from the load controller, it is possible to suppose approximate load current, when typical current value is beforehand registered every load. In case where the load current value is directly transmitted, it is possible to know the current more correctly. Also, the information relating to the whole load current is input from the current sensor 23.

If the load current largely exceeds the maximum output current of the electric generator flows, large discharge current from the battery flows, as a result the battery terminal voltage Vb decreases in accordance with equation 1. The power supply voltage expecting part 35 expects the voltage drop in accordance with the expectation value of the load current and the battery condition, and the load control commanding part 39 has a task for preventing the voltage drop by limiting beforehand the operation of the load according to need.

The electric generator maximum output current monitoring part 34, the power supply voltage predicting part 35, the load control current calculating part 37, the load limit control allocating part 38, the load control commanding part 39 and the electric generator commanding part 40 are explained hereinafter.

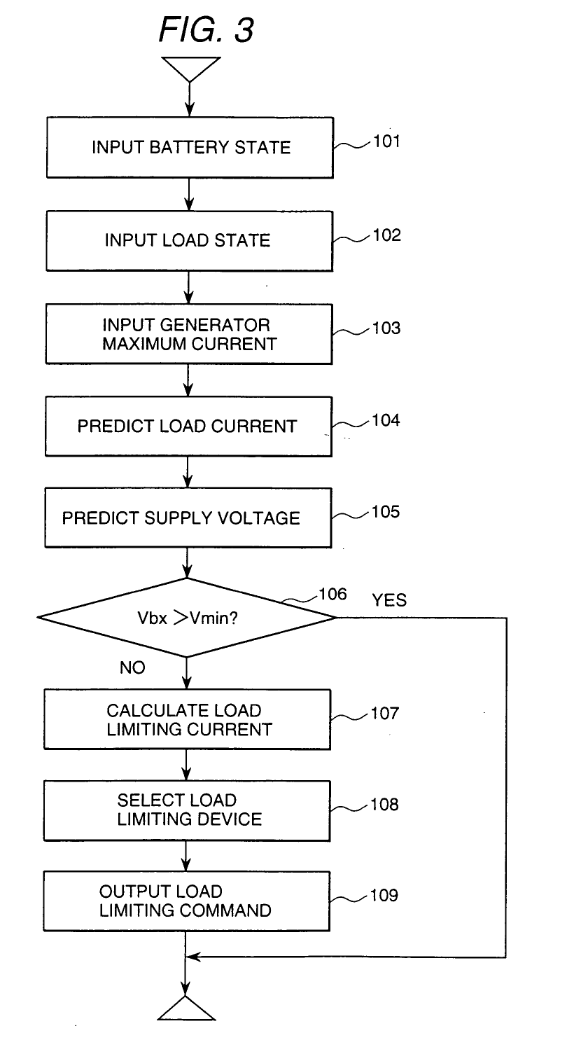

Referring to FIG. 3, the operation of the power control unit 11 is explained. First, in Step 101 the battery condition at present time is input from the battery condition monitoring part 32. Concretely, the measured values or supposed values the respective values Vb, Vo, R and Ib. Next, in Step 102 the load condition is input from load condition monitoring part 33. Concretely, the current values of the respective electric loads and the total load current value are input. Further, in Step 103 the maximum output current of the electric generator is input from the electric generator maximum output current monitoring part 34. In general, since the maximum output is determined by the number of rotation, the maximum output current of the electric generator can be obtained by inputting the rotation number information.

Incidentally, there is following relation between the total load current Ic, the battery current Ib and the electric generator current Ia.

Ia=Ib+Ic (2)

In this example, in Steps 101 and 102 the battery current Ib and total load current Ic have been obtained, so the electric current Iaa can be obtained by adding them. If the electric generator current Ia can be measured, the total load current Ic is not be needed to be measured, the total load current Ic can be obtained by subtracting the battery current Ib from the electric generator current Iaa.

Next, in Step 104, the estimated value of the load current Icx is calculated. For example, it is supposed that the electric load 16b is transmitted by a dynamo-electric brake, and the information of a brake pedal from the operation switch 14b is transmitted to the power control unit 11. When it is supposed that the brake pedal is stepped on and the information of brake-on was input, after that the load of the dynamo-electric brake rises up soon, and it can judge that the load current will increase. When the maximum load current of the dynamo-electric brake is supposed 100 A for example, the current increase up to 100 A may occur.

Alternately, it is supposed that the electric load 16c is a dynamo-electric power steering system for example, and the information relating to the command value to the motor is transmitted from the load controller 15c to the power control unit. If the relationship between the command value and the current value is prepared as data, it is possible to calculate the valuation of subsequent load current from the command value information.

Over all of the electric loads thee valuation of the current is predicted from such ON/OFF information and command value information, etc., and by adding the amount of variation to the present load current Ic the estimation value Icx of the load current is obtained.

Next, in Step 105 the variation of the battery voltage in terms of the variation of the load current is supposed. This is carried out power supply voltage predicting part 35. If the maximum output current of the electric generator is Imax, the discharge current from the battery in terms of the load current estimation value Icx is obtained in accordance with the following equation.

Ibx=Icx−Imax (3)

If this discharge current Ibx is substituted to the battery current in Equation 1, it is possible to obtain the estimation value Vbx of the battery voltage. When a voltage drop at the power supply line is excepted, the battery voltage becomes the voltage of the power supply line.

Incidentally, in this example, the estimation value of the battery current was obtained based on the maximum output current of the electric generator, but the variation of the electric generator current receives some response delay. Therefore, in case where a large current load rise up rapidly, the response of the electric generator can not follow to this, and a voltage drop can occur. At that time in Equation 3 in place of the maximum current Imax of the electric generator the discharge current Ibx may be evaluated by using the present electric generator current Ia.

Next, in Step 106 the estimation value of thee battery voltage Vbx is judged whether it is larger than a predetermined minimum voltage Vmin. This is carried out by the power supply voltage judging part 36. If the minimum voltage Vmin is 14 V power supply system for example, it is set to 8 V. In case where as a voltage which can demonstrate sufficiently the function of a large power load more large voltage value is requested, 10 V for example may be set. In case of the 42 V power supply system, 30 V for example is set.

In case where the estimation value of the battery voltage Vb is sufficiently larger than the minimum voltage Vmin, since there is no need particularly the load limitation, the Step is ended without issuing the load limitation command.

In case where the estimation value of the battery voltage Vbx is smaller than the minimum voltage Vmin the process advances to Step 107.

In Step 107, the load current to be limited is calculated. This is carried out by load limit current operating or calculating part 37. For a short period of time, it can think that a voltage drop due to the internal resistance is ruling, so the load limit current Icd is obtained from the difference between the estimation value of thee battery voltage and the minimum voltage as follows.

Icd=(Vmin−Vbx)/R (4)

Next, in Step 108 the load limit current is allocated to the electric load. This is carried out by the load limit current allocating part 38. First, a level of importance is set to the respective electric loads beforehand. For example, a load absolutely can not be limited such as the load directly associated to the running of the automobile or the like is set to Level 1, a load which does not wish hopefully to be limited but in some case may be limited is set to Level 2, and a load such as an air conditioner which is not associated to the running of the automobile and may be limited is set to Level 3. Also, a current which is possible to be limited may calculate in advance every load equipment. In the load limitation, in the case of an equipment which turns off a switch the present load current is given as thee current which is possible to be limited, as it is. In the case of equipment which the load limitation is carried out by the output decrease not the switch-off, the current value which is possible to decrease is treated as the current which is possible to be limited.

Various methods of selecting the equipments can be thought, but for example, an equipment is selected which becomes a limitation object by turns the magnitude of the current which is possible to be limited, and the selected equipments are increased until the total of the currents which are possible to be limited becomes larger than the load limit current obtained in Step 108. Alternately, there is also a method in which an order of priority is beforehand set every equipment not in the order of the magnitude of the current which is possible to be limited, the equipment is selected in accordance with that order of priority.

The selection is carried out for the loads of Level 3, in case where the load limit current cannot be attained even if the loads of Level 3 are wholly selected, as well as the loads of Level 2 the limited equipment is selected at the similar procedure. In case where shortage exists even if the whole loads of Level 2, since any more loads cannot be limited, the selection finishes.

Lastly, in Step 109, a load limit command is generated for the load controller of the selected load control equipment. This is carried out by the load control commanding part 39.

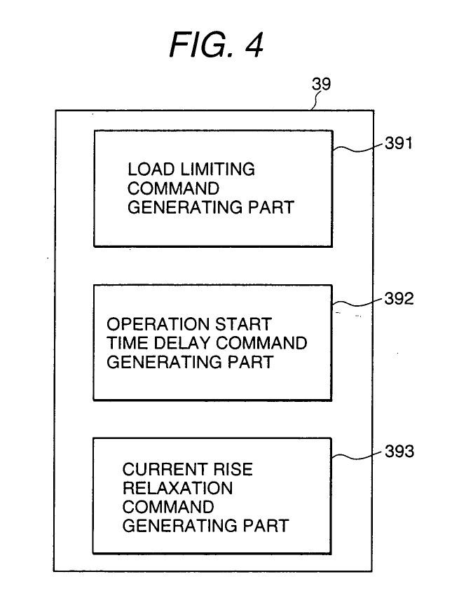

Referring to FIG. 4, an example of the load control commanding part 39 is explained. In this example, the load control commanding part 39 comprises a load limiting command generating part 391, an operation start time delay generating part 392 and a current rise relaxation command generating part 393.

The load limiting command generating part 391 generates a load limit command such as the switch-off command of the electric load, the output decrease command of the electric load, etc. With such arrangement, in this example it is possible to carry out the necessary load limitation beforehand for the turn-on command of the large power load, so as thereby to avoid the voltage drop.

Incidentally, in case where, when a large power load whose importance is low is risen, the voltage drop due to that can be estimated, it is appropriate to limit the rise its load itself. Therefore, in selecting a load limit equipment, also a load which is under the operation command and through which actually current does not flow yet is enclosed in the limitation object.

The operation start time delay command generating part 392 generates an operation start time delay command for delaying the operation start time of the electric load. In the above-mentioned example, the load limitation was carried out to avoid the voltage drop, but in case where, before the load current decreases by the load limit command, the current increases by the turn-on of a new load, voltage drop occurs transiently by just that much. At that time, it is useful that for the turn-on request of the load equipment a command is issued to delay the turn-on by a predetermined period of time. However, there is an equipment of which delay con not be accepted for the operation of the equipment, as the dynamo-electric brake, for example. At that time, the setting of delay time must be necessary every equipment to be turned on.

The current rise relaxation command generating part 393 generates a command for making graduate the turning-on of the current of an electric load. In case where a transitional voltage drop is worried about as a consequence that the internal resistance is high, it is also useful to make graduate the turning-on the current of the load equipment. In this example, the current rise relaxation command generating part 393 generate the command to the load controller so that the current rise at the equipment side has the delay corresponding to the response delay of the electric generator.

Incidentally, by using the flow in FIG. 3, the procedure of limiting the load current to avoid the voltage drop was explained, but for the limited load the limitation is released serially after the voltage recovered. For example, in above-mentioned Step 106, as a result of the comparison of the voltage estimation value with the minimum voltage when the estimation value is larger than the minimum value, the limited load current can be released. Concretely, since the load current can be increased up to current Ici calculated by following Equation 5, for the load under the limitation the limitation may be released within its extent.

Ici=(Vbx−Vmin)/R (5)

Next, the operation of the electric generator commanding part 40 is explained. The electric generator commanding part 40 gives a command to the electric generator 12 as a voltage target value. For example, the command of the target value is carried out, as 14 V for the 14 V power supply system, 42 V for the 42 V power supply system, and all that. In case where it is necessary that the charge condition of the battery must be administrated, the voltage is set so that the charging condition of the target can be obtained based on the sensed result of the battery condition by means of the battery condition monitoring part 32, and such is commanded. In the electric generator 12, the electric generator output current is controlled so that the given voltage target value is obtained.

As mentioned above, since the electric generator has a response delay, there is the possibility that the voltage of the power supply system drops transitionally by the rise of a large current load. Specially, in case where the internal resistance of the battery is high as in low ambient air temperature, the voltage drop is large. Then, in case where the internal resistance sensed by the battery condition monitoring part 32 is larger than a set value, the target voltage value is set beforehand highly.

For example, in the 14 V power supply system, the voltage target value is set to 15 V which is a higher value. Since the amount of transitional voltage drop due to the load turning-on is the same, the voltage at the time of the voltage drop becomes high by 1 V, and a possibility that a malfunction of the equipment due to voltage drop and the like can be avoided.

Thus, changing the target voltage value of the electric generator corresponding to the battery condition is effective in avoiding the transient voltage drop. However, since there is an upper limit for the voltage which is possible to be set by the kind of battery and the condition thereof, it is needed to decide the upper limit value by considering it.

Incidentally, within the electric generator used in the above-mentioned explanation, a usual alternator, a motor-generator which enables also the start of the engine and the like can be enclosed, but basically these are all the same. However, since there is a difference in responsibility, it is needed to set the rise characteristic, etc. corresponding thereto. Further, since in the case of the motor-generator there is a circumstance in which power generation is not possible by a torque assist operation or the like, it is needed to estimate the voltage considering it.

The above-mentioned explanation related to the fact that the battery condition monitoring part 32 is enclosed the power control unit 11, but this is not limiting. For example, it is possible that this function has in the battery sensor 21. In this case, in place of the information of the battery current, voltage and temperature, the sensed result of the battery condition is transmitted to the power control unit 11 through the communication line 2.

Although an example of this invention has been explained hereinabove, this invention is not limited by the above-mentioned example. As is clear to those skilled in the art, this invention is possible to be modified variously within the scope the claims.

What is claimed is:

1. A power supply system having a power supply including an electric generator and a battery, and a power control unit for controlling electric power supplied from said power supply to an electric load, wherein said power supply system has battery condition sensing means for sensing the operative condition of said battery and load condition sensing means for sensing the operative condition of said electric load, and said power supply system has a function in which the variation of the power supply voltage at the time of the operative requirement of said electric load is estimated based on the condition of said battery and the operative condition of said electric load, and the current of the electric load is limited when said estimated electric power supply voltage is smaller than a predetermined value.

2. A power supply system according to claim 1 wherein the variation of said power supply voltage is estimated in consideration of the maximum output current of said electric generator.

3. A power supply system according to claim 1 wherein the current of said electric load is limited in consideration of the level of importance said electric load and the magnitude of current.

4. A power supply system according to claim 1 wherein it has a function in which the start of operation of said electric load is delayed by a predetermined time at the time of the operative requirement of the electric load.

5. A power supply system according to claim 1 wherein a command to make the rise of said electric load less severe based on said battery condition at the time the operative requirement of the electric load is provided.

6. A power supply system having a power supply including an electric generator and a battery, and a power control unit for controlling electric power supplied from said power supply to an electric load, wherein said power supply system has battery condition sensing means for sensing the operative condition of said battery, and said power supply system has a function in which a target voltage value to electric generator is commanded based of the battery condition sensed by said battery condition sensing means.
